(19) United States
(12) Patent Application Publication
(10) Pub. No.: US 2026/0369168 A1
(43) Pub. Date: Nov. 19, 2026

(54) FLIGHT PLAN MANAGEMENT DEVICE, FLIGHT PLAN MANAGEMENT METHOD, AND RECORDING MEDIUM

(71) Applicant: NEC CORPORATION, Tokyo (JP)

(72) Inventor: Shinji NAKADAI, Tokyo (JP)

(73) Assignee: NEC CORPORATION, Tokyo (JP)

(21) Appl. No.: 19/136,972

(22) PCT Filed: Dec. 16, 2022
(86) PCT No.: PCT/JP2022/046361

§ 371 Date: Jun. 9, 2025

(51) Int. Cl. G08G 5/32; G01C 21/20

(52) U.S. Cl. CPC G08G 5/32; G01C 21/20

(57) ABSTRACT

The flight plan acquisition means acquires a flight plan. The device information acquisition means acquires device information of a mobile unit. The weather information acquisition means acquires weather information. The movement speed prediction means predicts a movement speed of the mobile unit based on the flight plan, the device information, and the weather information. The flight plan management means manage a flight plan based on prediction results.

### TECHNICAL FIELD

This disclosure relates to management of operation plans for mobile units.

### BACKGROUND ART

In order to fly drones, it is necessary to reserve a spatiotemporal space (three-dimensional space and time) to be used. Therefore, when there is uncertainty in wind direction and wind speed during a flight plan time of a drone, and the spatiotemporal space to be used cannot be determined, a larger reservation frame as a buffer may be allocated. However, allocating a larger reservation frame reduces spatial utilization efficiency, which is undesirable from a public perspective. On the other hand, if a smaller reservation frame is allocated, when the wind direction and wind speed change significantly, it becomes necessary to make a new reservation, resulting in increased effort. Patent Document 1 describes a method in which, when an abnormal situation such as a sudden deterioration in weather occurs, a new flight plan is created and set in the unmanned aerial vehicle.

### PRECEDING TECHNICAL REFERENCES

### Patent Document

Patent Document 1: Japanese Patent Application Laid-Open under No. 2019-163992

### SUMMARY

### Problem to be Solved by the Invention

However, Patent Document 1 does not consider a method for adjusting spatiotemporal space using weather information.

One object of the present disclosure is to provide a flight plan management system that adjusts the spatiotemporal space to be used in accordance with the wind direction and wind speed.

### Means for Solving the Problem

According to an example aspect of the present disclosure, there is provided a flight plan management device, comprising:
a flight plan acquisition means configured to acquire a flight plan;
a device information acquisition means configured to acquire device information of a mobile unit;
a weather information acquisition means configured to acquire weather information;
a movement speed prediction means configured to predict a movement speed of the mobile unit based on the flight plan, the device information, and the weather information; and
a flight plan management means configured to manage a flight plan based on prediction results.

According to another example aspect of the present disclosure, there is provided a flight plan management method comprising:
acquiring a flight plan;
acquiring device information of a mobile unit;
acquiring weather information;
predicting a movement speed of the mobile unit based on the flight plan, the device information, and the weather information; and
managing a flight plan based on prediction results.

According to a further example aspect of the present disclosure, there is provided a recording medium recording a program, the program causing a computer to perform a process comprising:
acquiring a flight plan;
acquiring device information of a mobile unit;
acquiring weather information;
predicting a movement speed of the mobile unit based on the flight plan, the device information, and the weather information; and
managing a flight plan based on prediction results.

### EFFECT OF THE INVENTION

According to the present disclosure, it is possible to adjust the spatiotemporal space to be used in accordance with the wind direction and wind speed.

### BRIEF DESCRIPTION OF THE DRAWINGS

FIG. 1 illustrates an overall configuration of a flight plan management system according to a first example embodiment.

FIG. 2 is a block diagram illustrating a hardware configuration of a terminal device.

FIG. 3 is a block diagram illustrating a hardware configuration of a server.

FIG. 4 is a block diagram illustrating a functional configuration of the server.

FIG. 5 illustrates an example of an input screen of device information and a flight plan.

FIG. 6 illustrates an example of a flight plan.

FIG. 7 illustrates an example of adjustment of the flight plan.

FIG. 8 illustrates another example of adjustment of the flight plan.

FIG. 9 illustrates another example of adjustment of the flight plan.

FIG. 10 illustrates a display example of the flight plan after adjustment transmitted by the server.

FIG. 11 is a flowchart of a flight plan adjustment process.

FIG. 12 is a block diagram illustrating a functional configuration of a flight plan management device of a second example embodiment.

FIG. 13 is a flowchart of a process by the flight plan management device of the second example embodiment.

### EXAMPLE EMBODIMENTS

### First Example Embodiment

### [Overall Configuration]

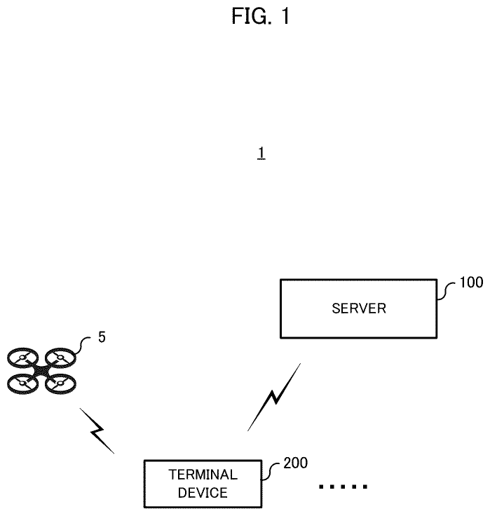

FIG. 1 shows an overall configuration of a flight plan management system to which a flight plan management device according to the present disclosure is applied. The flight plan management system 1 includes a drone 5, a server 100, and a terminal device 200. The server 100 is an example of a flight plan management device. The server 100 and the terminal device 200 can communicate wirelessly or wired. Further, the terminal device 200 and the drone 5 can communicate wirelessly. Further, it is assumed that a plurality of terminal devices 200 and a plurality of drones 5 are present.

The terminal device 200 is operated by an operator of the drone. Device information and a flight plan of the drone 5 are input into the terminal device 200. The device information refers to information about the drone 5 itself, including details such as its model type. The device information is transmitted from the drone 5 to the terminal device 200. The flight plan also refers to a flight plan for the drone 5, and includes information such as departure date and time, estimated arrival date and time, and a flight route. The operator registers the flight plan in advance on the server 100 as a reservation for a spatiotemporal space to be used.

The server 100 manages the flight plan of the plurality of drones in a database. The server 100 also adjusts the flight plan of the drones. Specifically, the server 100 receives information such as the device information and the flight plan of the drone 5 from the terminal device 200. Further, the server 100 acquires weather information for the departure date of the drone 5 from external websites or the like, at predetermined intervals. The weather information includes predicted wind direction, predicted wind speed, and the like for each predetermined interval. Then, the server 100 predicts the movement speed of the drone 5 using the device information and the flight plan of the drone 5, and the weather information. If the server 100 determines that the drone 5 will deviate from the range of the original flight plan when flying at the predicted movement speed, the server 100 modifies the flight plan and updates the database. The server 100 discloses the contents of the updated database to other operators. The server 100 also transmits the modified flight plan to the terminal device 200.

Thus, the server 100 can predict the movement speed of the drones and adjust the flight plan so that operators do not have to check the weather each time and concentrate on pre-flight preparations.

### [Hardware Configuration]

### (Terminal Device)

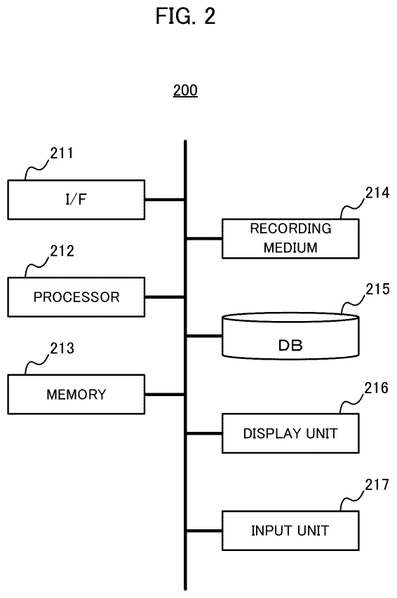

FIG. 2 is a block diagram illustrating a hardware configuration of the terminal device 200. The terminal device 200 is, for example, a PC, a tablet, or the like. As illustrated, the terminal device 200 includes an interface (I/F) 211, a processor 212, a memory 213, a recording medium 214, a database (DB) 215, a display unit 216, and an input unit 217.

The I/F 211 transmits data to and receives data from external devices. Specifically, the terminal device 200 receives the device information of the drone 5 from the drone 5 through the I/F 211. The terminal device 200 transmits the device information, the flight plan, and the like of the drone 5 to the server 100 through the I/F 211.

The processor 212 is a computer such as a CPU (Central Processing Unit), and controls the entire terminal device 200 by executing programs prepared in advance. The processor 212 may be a GPU (Graphics Processing Unit), a TPU (Tensor Processing Unit), a DSP (Digital Signal Processor), a MPU (Micro Processing Unit), a FPU (Floating point number Processing Unit), a PPU (Physics Processing Unit), a quantum processor, a FPGA (Field-Programmable Gate Array), or the like.

The memory 213 may be configured by a ROM (Read Only Memory), a RAM (Random Access Memory), and the like. The memory 213 is also used as working memory during various processing operations by the processor 212.

The recording medium 214 is a non-volatile and non-temporary recording medium such as a disk-like recording medium or a semiconductor memory, and is configured to be detachable from the terminal device 200. The recording medium 214 records various programs executed by the processor 212. When the terminal device 200 executes various processes, the program recorded in the recording medium 214 is loaded into the memory 213 and executed by the processor 212.

The DB 215 stores data used by the terminal device 200 as well as data generated by the terminal device 200. Specifically, DB 215 stores the device information transmitted from the drone 5 and the flight plan, etc. input by the operator.

The display unit 216 is, for example, a liquid crystal display, and displays a screen for inputting the flight plan or the like to the operator. The display unit 216 displays information transmitted from the server 100. The input unit 217 is, for example, an input device such as a keyboard, a mouse, or the like, and is used by the operator to input the flight plan or the like.

### (Server)

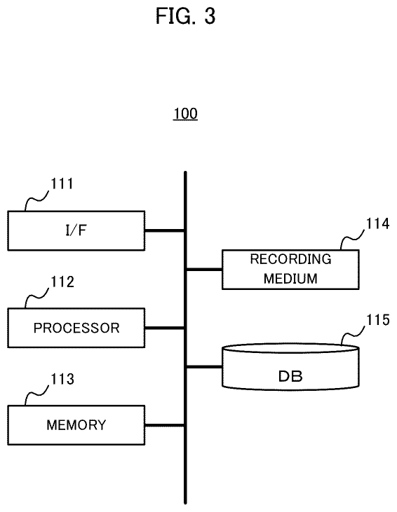

FIG. 3 is a block diagram illustrating a hardware configuration of the server 100. As illustrated, the server 100 includes an interface (I/F) 111, a processor 112, a memory 113, a recording medium 114, and a database (DB) 115.

The I/F 111 transmits data to and receives data from external devices. Specifically, the servers 100 receives information such as the device information, the flight plan, and the like of the drone 5 from the terminal device 200 through the I/F 111. The server 100 also transmits the modified flight plan to the terminal device 200 through the I/F 111. In addition, the server 100 acquires the weather information for the departure date of the drone 5 from external websites or the like through the I/F 111.

The processor 112 is a computer such as a CPU, and controls the server 100 in its entirety by executing a program prepared in advance. Note that the processor 112 may be a GPU, a TPU, a quantum processor, a FPGA, or the like. The processor 112 performs the flight plan adjustment process, as will be described later.

The memory 113 is configured by a ROM, RAM, or the like. The server 100 may use the memory 113 as working memory during various processing operations by the processor 112.

The recording medium 114 is a non-volatile and non-temporary recording medium such as a disk-like recording medium or a semiconductor memory, and is configured to be detachable from the server 100. The recording medium 114 records various programs executed by the processor 112. When the server 100 executes various processes, the program recorded in the recording medium 114 is loaded into the memory 113 and executed by the processor 112.

The DB 115 stores data used by the servers 100. Specifically, the DB 115 stores the flight plans for the plurality of drones. The server 100 may include an input unit such as a keyboard and a mouse, and a display unit such as a liquid crystal display, thereby to allow an administrator to give instructions or inputs.

### [Function Configuration]

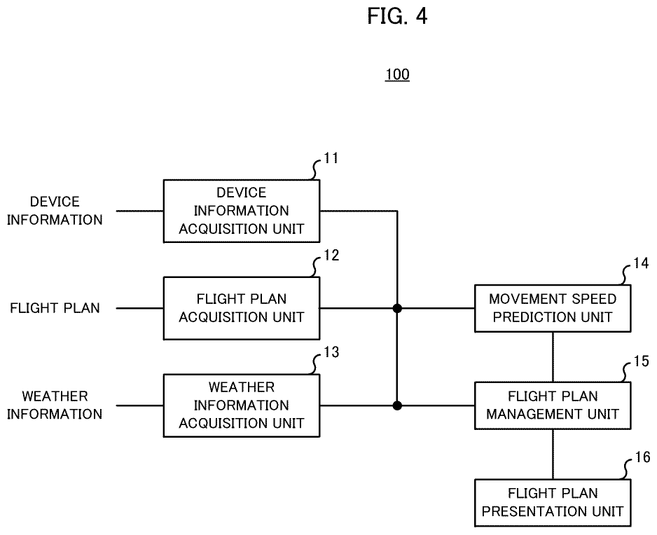

FIG. 4 is a block diagram illustrating a functional configuration of the server 100. The server 100 functionally includes a device information acquisition unit 11, a flight plan acquisition unit 12, a weather information acquisition unit 13, a movement speed prediction unit 14, a flight plan management unit 15, and a flight plan presentation unit 16.

The terminal device 200 acquires information from the drone and the operator. Specifically, the terminal device 200 acquires the device information transmitted by the drone, and the flight plan input by the operator, and transmits them to the server 100.

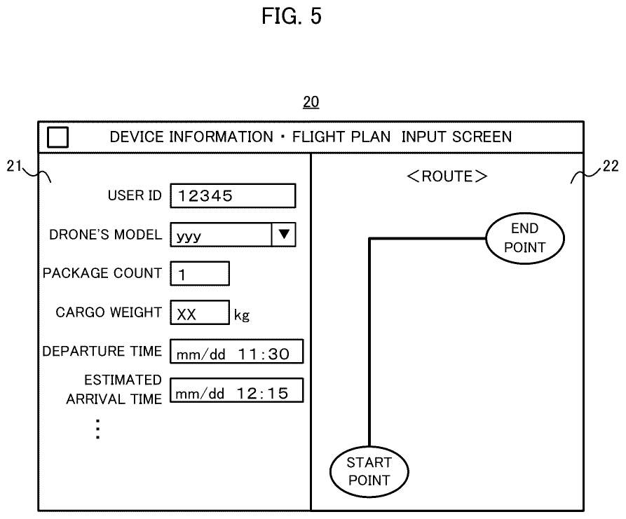

FIG. 5 illustrates an example of the input screen for the device information and the flight plan. The terminal device 200 transmits the data input on the input screen to the server 100. FIG. 5 displays basic information 21 and a route 22 on the input screen 20. The basic information 21 includes the device information and the flight plan of the drone in addition to the user ID. The device information of the drone includes, for example, details such as the drone's model. In addition, the flight plan includes, for example, information such as the cargo to be loaded onto the drone, the drone's departure date and time, and the drone's estimated arrival date and time. The operator may manually input the device information into the terminal device 200. Alternatively, the terminal device 200 may automatically reflect the information received from the drone. The operator may manually input the estimated arrival date and time into the terminal device 200. The server 100 or the terminal device 200 may predict the estimated arrival date and time of the drone, and automatically reflect the result. The route 22 is the flight route of the drone. The route 22 is part of the flight plan. The terminal device 200 may accept the setting of the route 22 from the operator, or may generate an optimal flight route by accepting the departure point and the arrival point as settings from the operator.

Returning to FIG. 4, the server 100 receives the device information and the flight plan from the terminal device 200. The device information acquisition unit 11 receives the device information from the terminal device 200, and the flight plan acquisition unit 12 receives the flight plan from the terminal device 200. In addition, the weather information acquisition unit 13 acquires the weather information from the Meteorological Agency website or the like, at predetermined intervals.

The device information acquisition unit 11 acquires performance and specification information such as the standard speed, the maximum speed, and the maximum flight time of the drone, from a database or the like prepared in advance, based on the drone's model and other data included in the device information. Then, the device information acquisition unit 11 outputs the device information including the performance and specifications to the movement speed prediction unit 14 and the flight plan management unit 15.

The flight plan acquisition unit 12 outputs the flight plan to the movement speed prediction unit 14 and the flight plan management unit 15. The weather information acquisition unit 13 outputs the weather information to the movement speed prediction unit 14 and the flight plan management unit 15.

The movement speed prediction unit 14 acquires the device information from the device information acquisition unit 11, acquires the flight plan from the flight plan acquisition unit 12, and acquires the weather information from the weather information acquisition unit 13. Then, the movement speed prediction unit 14 predicts the movement speed of the drone. Specifically, the movement speed prediction unit 14 calculates the movement speed of the drone based on the flight route of the drone included in the flight plan, the standard speed of the drone included in the device information, and the predicted wind direction and wind speed included in the weather information.

For example, when a tailwind is blowing, the movement speed prediction unit 14 adds a predetermined value corresponding to the wind speed to the drone's standard speed and calculates the movement speed. When a headwind is blowing, the movement speed prediction unit 14 subtracts a predetermined value corresponding to the wind speed from the drone's standard speed and calculates the movement speed. In addition, when wind is blowing from other directions, the movement speed prediction unit 14 represents the wind direction and speed as a vector with respect to the drone's traveling direction as the reference direction, and calculates the component of the reference direction of the wind. Then, the movement speed prediction unit 14 adds a predetermined value predetermined in accordance with the component of the reference direction of the wind to the standard speed of the drone, and calculates the movement speed. The movement speed prediction unit 14 outputs the predicted movement speed of the drone (hereinafter, also referred to as “predicted movement speed”.) to the flight plan management unit 15.

In the above, the movement speed prediction unit 14 calculates the movement speed using the standard speed of the drone, but instead of the standard speed of the drone, a predetermined speed may be used. The movement speed prediction unit 14 may, for example, determine a predetermined speed within a range that does not exceed the maximum speed of the drone, in accordance with the operator's piloting skill. In addition, if laws or regulations specify a legal speed for the drone's flight area, the movement speed prediction unit 14 may calculate the movement speed using the legal speed.

The flight plan management unit 15 acquires the device information from the device information acquisition unit 11, acquires the flight plan from the flight plan acquisition unit 12, acquires the weather information from the weather information acquisition unit 13, and acquires the predicted movement speed from the movement speed prediction unit 14. The flight plan management unit 15 predicts the drone's trajectory, and the like in the spatiotemporal space based on the flight plan and the predicted movement speed. Then, the flight plan management unit 15 determines whether the predicted result is within the range of the flight plan of the drone. When the predicted result is not within the range of the flight plan of the drone, the flight plan management unit 15 adjusts the flight plan. Then, the flight plan management unit 15 updates the flight plan stored in the database 115 based on the adjusted flight plan (hereinafter, also referred to as “adjusted flight plan”). The flight plan management unit 15 outputs the adjusted flight plan to the flight plan presentation unit 16. The flight plan management unit 15 performs the above-described determination at each predetermined time from before the drone's departure until drone's arrival at the destination, and adjusts the flight plan accordingly.

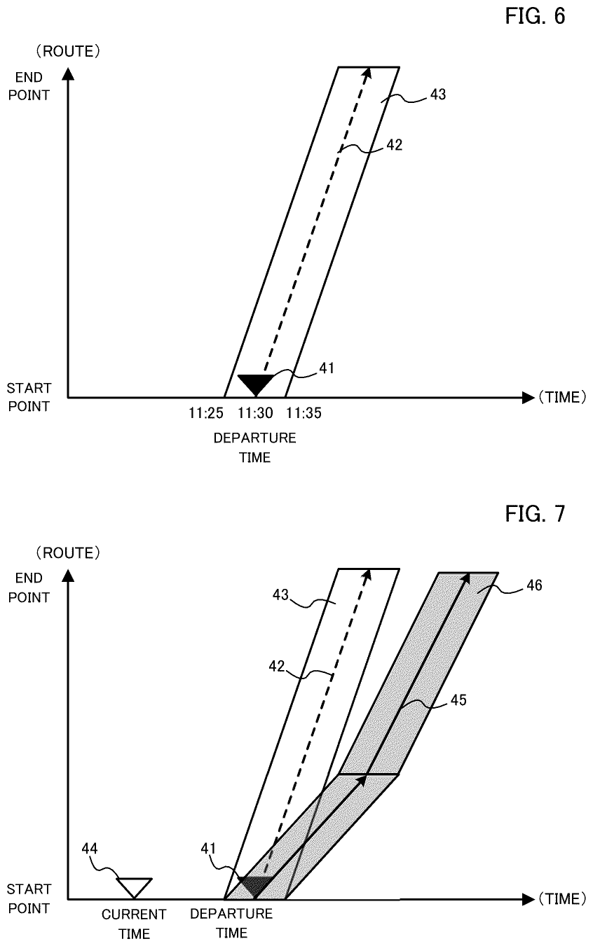

FIG. 6 to FIG. 9 illustrates examples of the adjustment of the flight plan by the flight plan management unit 15.

FIG. 6 illustrates an example of a flight plan. FIG. 6 includes a departure time 41, a spatiotemporal trajectory 42, and a flight planning space 43. The departure time 41 refers to the departure time of the drone defined in the flight plan. The spatiotemporal trajectory 42 represents the drone's path in space and time, i.e., the trajectory of the drone within the spatiotemporal domain. The spatiotemporal trajectory 42 is generated based on the geographic route from the start point to the end point, the departure time of the drone, and the movement speed of the drone. The drone's movement speed is determined, for example, based on information such as the drone's standard speed, and the predicted wind direction and wind speed on the departure day at the time of the flight plan creation. The flight planning space 43 is a space generated by adding a buffer (buffer space) around the spatiotemporal trajectory 42. In FIG. 6, the departure time 41 of the drone is 11:30, and the buffer of 5 minutes is set before and after the departure time. The operator registers the flight planning space in the database 115 in advance.

FIG. 7 illustrates an example of the adjustment of the flight plan. FIG. 7 includes a current time 44, a prediction spatiotemporal trajectory 45, and a prediction flight planning space 46 in addition to the departure time 41, the spatiotemporal trajectory 42 and the flight planning space 43. The prediction spatiotemporal trajectory 45 refers to the spatiotemporal trajectory predicted by the flight plan management unit 15. The prediction spatiotemporal trajectory 45 is generated based on the geographic route from the start point to the end point, the departure time of the drone, and the predicted movement speed of the drone. The movement speed prediction unit 14 predicts the predicted movement speed of the drone using the latest predicted wind direction and wind speed at the current time 44. In FIG. 7, the prediction spatiotemporal trajectory 45 is outside the range of the flight planning space 43, and it is assumed that the operator will be unable to fly the drone within the range of the flight planning space 43. Therefore, the flight plan management unit 15 generates the prediction flight planning space 46 by adding a buffer (buffer space) around the prediction spatiotemporal trajectory 45. The prediction flight planning space 46 is an example of the adjusted flight plan described above.

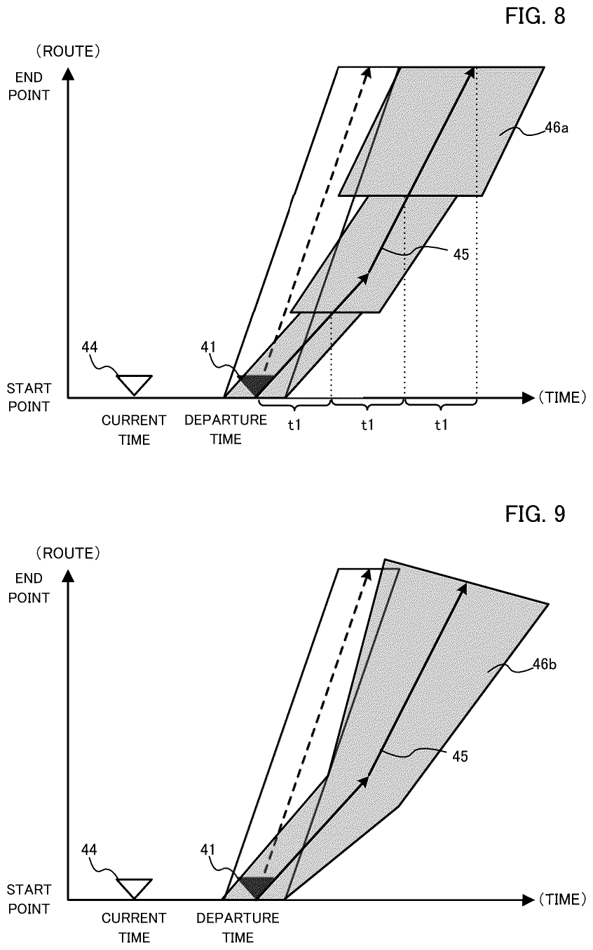

FIG. 8 and FIG. 9 illustrate other examples of the adjustment of the flight plan. As time progresses from the departure time 41, the predicted wind direction and wind speed are likely to change from the original prediction, meaning that the uncertainty of the prediction becomes high. Therefore, the flight plan management unit 15 deals with the above-described uncertainty by widening the width of the buffer space with the time progresses. In FIG. 8, the flight plan management unit 15 generates the prediction flight planning space 46a by widening the width of the buffer space for each predetermined time t1 from the departure time. In FIG. 9, the flight plan management unit 15 gradually widens the width of the buffer space in accordance with the elapse of time from the departure time to generate the prediction flight planning space 46b. The prediction flight planning space 46a and the prediction flight planning space 46b are examples of the adjusted flight plan described above.

Returning to FIG. 4, the flight plan presentation unit 16 generates display data based on the adjusted flight plan acquired from the flight plan management unit 15, and transmits the display data to the terminal device 200.

In the above-described configuration, the device information acquisition unit 11 is an example of a device information acquisition means, the flight plan acquisition unit 12 is an example of a flight plan acquisition means, the weather information acquisition unit 13 is an example of a weather information acquisition means, the movement speed prediction unit 14 is an example of a movement speed prediction means, the flight plan management unit 15 and the flight plan presentation unit 16 are examples of a flight plan management means.

### [Display Example]

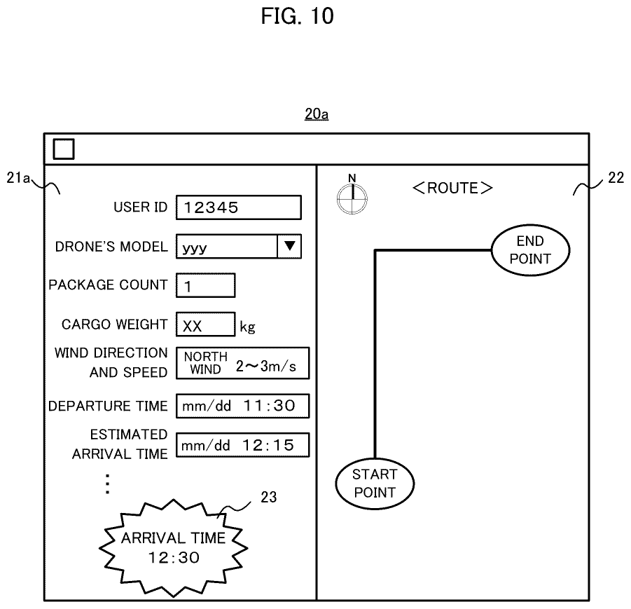

FIG. 10 illustrates a display example of the adjusted flight plan transmitted by the server 100. In this case, the basic information 21a, the route 22, and the arrival time 23 are displayed on the device information and flight plan input screen 20a. The basic information 21a includes information about wind direction and wind speed in addition to the user ID, the device information and the flight plan of drones. The arrival time 23 indicates the arrival time when the flight is conducted according to the adjusted flight plan. As shown in FIG. 10, the operator can recognize that changes in weather may affect the arrival time.

### [Flight Plan Adjustment Process]

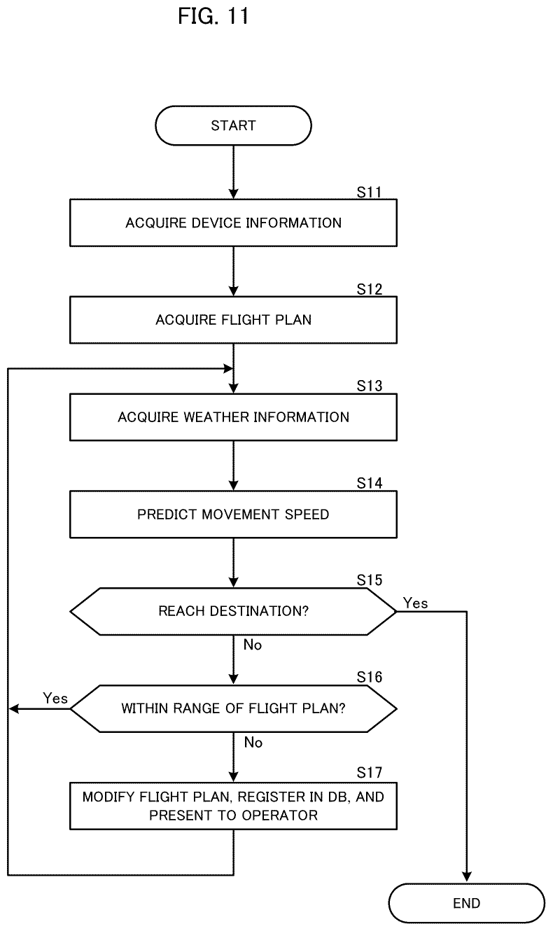

Next, the flight plan adjustment process will be described. FIG. 11 is a flowchart of a flight plan adjustment process by the server 100. This process is realized by the processor 112 illustrated in FIG. 3, which executes a program prepared in advance and operates as each element illustrated in FIG. 4.

First, the device information acquisition unit 11 acquires the device information from the terminal device 200, and outputs the device information to the movement speed prediction unit 14 and the flight plan management unit 15 (step S11). The flight plan acquisition unit 12 acquires the flight plan from the terminal device 200, and outputs the flight plan to the movement speed prediction unit 14 and the flight plan management unit 15 (step S12). The weather information acquisition unit 13 acquires the weather information from the terminal device 200, and outputs the weather information to the movement speed prediction unit 14 and the flight plan management unit 15 (step S13).

Next, the movement speed prediction unit 14 predicts the movement speed of the drone based on the device information, the flight plan, and the weather information (step S14). The movement speed prediction unit 14 outputs the predicted movement speed of the drone to the flight plan management unit 15.

Next, the flight plan management unit 15 determines whether the drone has reached the destination (step S15). If the drone has not reached the destination (step S15:No), the flight plan management unit 15 predicts the trajectory of the drone in the spatiotemporal space based on the flight plan and the predicted movement speed. Then, the flight plan management unit 15 determines whether the prediction result is within the range of the flight plan of the drone (step S16). If the prediction result is within the range of the flight plan of the drone (step S16:Yes), the process returns to the step S13. On the other hand, if the prediction result is outside the range of the flight plan of the drone (step S16:No), the flight plan management unit 15 modifies the flight plan, and registers the modified flight plan in the database 115. Then, the flight plan presentation unit 16 presents the modified flight plan to the operator (step S17).

In this way, the flight plan is modified as necessary until the drone reaches the destination, and when the drone arrives at the destination (step S15:Yes), the flight plan adjustment process ends.

### MODIFICATION

Next, modifications of the first example embodiment will be described. The following modifications can be combined as appropriate and applied to the first embodiment.

### Modification 1

In the above-described first example embodiment, the management of the flight plan is for drones; however, the scope of management is not limited to drones, and may also include various unmanned aerial vehicles and unmanned transport vehicles that fly under external control.

### Modification 2

In the above-described first example embodiment, the server 100 updates the database 115 based on the adjusted flight plan, and then transmits the adjusted flight plan to the terminal device 200. However, the application of the present disclosure is not limited thereto. For example, the server 100 may first transmits the adjusted flight plan to the terminal device 200 to request approval for the change in the flight plan, and only update the database 115 if the operator approves it.

### Second Example Embodiment

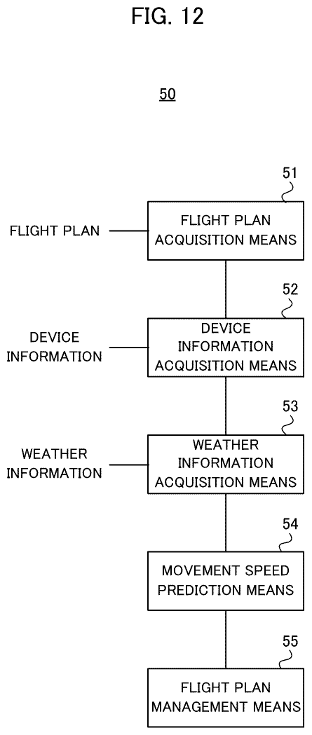

FIG. 12 is a block diagram illustrating a functional configuration of a flight plan management device 50 according to the second example embodiment. The flight plan management device 50 of the second example embodiment includes a flight plan acquisition means 51, a device information acquisition means 52, a weather information acquisition means 53, a movement speed prediction means 54, and a flight plan management means 55.

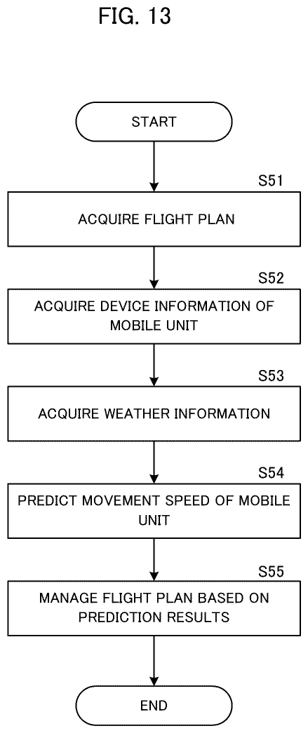

FIG. 13 is a flowchart of a process by the flight plan management device 50. The flight plan acquisition means 51 acquires a flight plan (step S51). The device information acquisition means 52 acquires device information of a mobile unit (step S52). The weather information acquisition means 53 acquires weather information (step S53). The movement speed prediction means 54 predicts a movement speed of the mobile unit based on the flight plan, the device information, and the weather information (step S54). The flight plan management means 55 manage a flight plan based on prediction results (step S55).

According to the flight plan management device 50 of the second example embodiment, it is possible to adjust the spatiotemporal space to be used according to the weather information.

A part or all of the example embodiments described above may also be described as the following supplementary notes, but not limited thereto.

### Supplementary Note 1

A flight plan management device comprising:
a flight plan acquisition means configured to acquire a flight plan;
a device information acquisition means configured to acquire device information of a mobile unit;
a weather information acquisition means configured to acquire weather information;
a movement speed prediction means configured to predict a movement speed of the mobile unit based on the flight plan, the device information, and the weather information; and
a flight plan management means configured to manage a flight plan based on prediction results.

### Supplementary Note 2

The flight plan management device according to supplementary note 1, wherein
the flight plan includes a flight planning space;
the flight planning space includes a buffer space; and
the flight plan management means adjusts the flight planning space by changing the width of the buffer space for each predetermined time.

### Supplementary Note 3

The flight plan management device according to supplementary note 1, wherein
the flight plan includes a flight planning space;
the flight planning space includes a buffer space; and
the flight plan management means adjusts the flight planning space by widening the width of the buffer space in accordance with an elapse of time.

### Supplementary Note 4

The flight plan management device according to supplementary note 1, wherein, when adjusting the flight plan of the mobile unit, the flight plan management means registers the adjusted flight plan.

### Supplementary Note 5

The flight plan management device according to supplementary note 1, wherein, when adjusting the flight plan of the mobile unit, the flight plan management means outputs an adjustment result to a terminal device of an operator.

### Supplementary Note 6

The flight plan management device according to supplementary note 5, wherein the flight plan management means registers the adjustment result when the operator approves the adjustment result.

### Supplementary Note 7

A flight plan management method comprising:
acquiring a flight plan;
acquiring device information of a mobile unit;
acquiring weather information;
predicting a movement speed of the mobile unit based on the flight plan, the device information, and the weather information; and
managing a flight plan based on prediction results.

### Supplementary Note 8

A recording medium storing a program, the program causing a computer to perform a process comprising:
acquiring a flight plan;
acquiring device information of a mobile unit;
acquiring weather information;
predicting a movement speed of the mobile unit based on the flight plan, the device information, and the weather information; and
managing a flight plan based on prediction results.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

5 Drone
11 Device Information Acquisition Unit
12 Flight Plan Acquisition Unit
13 Weather Information Acquisition Unit
14 Movement Speed Prediction Unit
15 Flight Plan Management Unit
16 Flight Plan Presentation Unit
100 Server
200 Terminal Device

What is claimed is:

1. A flight plan management device comprising:
at least one memory configured to store instructions; and
at least one processor configured to execute the instructions to:
acquire a flight plan;
acquire device information of a mobile unit;
acquire weather information;
predict a movement speed of the mobile unit based on the flight plan, the device information, and the weather information; and
manage a flight plan based on prediction results.

2. The flight plan management device according to claim 1, wherein
the flight plan includes a flight planning space;
the flight planning space includes a buffer space; and
the one or more processors adjust the flight planning space by changing the width of the buffer space for each predetermined time.

3. The flight plan management device according to claim 1, wherein
the flight plan includes a flight planning space;
the flight planning space includes a buffer space; and
the one or more processors adjust the flight planning space by widening the width of the buffer space in accordance with an elapse of time.

4. The flight plan management device according to claim 1, wherein, when adjusting the flight plan of the mobile unit, the one or more processors register the adjusted flight plan.

5. The flight plan management device according to claim 1, wherein, when adjusting the flight plan of the mobile unit, the one or more processors output an adjustment result to a terminal device of an operator.

6. The flight plan management device according to claim 5, wherein the one or more processors register the adjustment result when the operator approves the adjustment result.

7. A flight plan management method comprising:
acquiring a flight plan;
acquiring device information of a mobile unit;
acquiring weather information;
predicting a movement speed of the mobile unit based on the flight plan, the device information, and the weather information; and
managing a flight plan based on prediction results.

8. A non-transitory computer readable recording medium storing a program, the program causing a computer to perform a process comprising:
acquiring a flight plan;
acquiring device information of a mobile unit;
acquiring weather information;
predicting a movement speed of the mobile unit based on the flight plan, the device information, and the weather information; and
managing a flight plan based on prediction results.
